(19) United States
(12) Patent Application Publication
(10) Pub. No.: US 2003/0100685 A1
(43) Pub. Date: May 29, 2003

(54) Polyamide formulations for embossed laminates

(76) Inventor: Nicholas Akos Farkas, Kingston (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/208,271

(22) Filed: Jul. 29, 2002

Related U.S. Application Data
(62) Division of application No. 09/155,146, filed on Feb. 3, 2000, now abandoned.
Application No. 09/155,146 is a 371 of international application No. PCT/CA97/00200, filed on Mar. 24, 1997.
(60) Provisional application No. 60/014,150, filed on Mar. 25, 1996.

(51) Int. Cl. C08L 77/00; B32B 27/08

(52) U.S. Cl. 525/432; 428/474.4

(57) ABSTRACT

Heat-sealable and formable polyamide laminating films with high temperature thermal stability. These properties permit the films to be used in monolayer structures, such as embossed laminates for high temperature insulating or cushioning applications. A multi-phase thermoplastic resin composition which may be used in the manufacture of heat formed embossed laminates which comprises at least one polyamide resin having a melting point greater than 200° C.; at least one polyamide resin having a melting point of less than 200° C., and the remainder comprises mainly ethylene polymers.

### CROSS-REFERENCE TO RELATED APPLICATIONS

This is a divisional of U.S. application Ser. No. 09/155,146, filed Feb. 3, 2000, herein incorporated by reference.

### FIELD OF THE INVENTION

The present invention relates to heat-sealable and formable polyamide films with high temperature thermal stability. These properties permit the films to be used in monolayer structures, such as embossed laminates for high temperature insulating or cushioning applications. A number of film formulations are described, and some of these are novel resin formulations.

### BACKGROUND OF THE INVENTION

Industry is always seeking new packaging and insulating materials that are cheaper and lighter and offer unique properties. In particular, there is a strong demand in the automotive business to develop materials which are not only cost effective, but also provide valuable solutions to address the need to meet ever stricter safety standards. A particular concern is the need for insulating materials that may be used in high temperature applications such as in heat shielding vehicle interiors when accidents or engine failures produce unsafe high temperature conditions which may be harmful to vehicle occupants at worst, or at best damaging to the interiors of such vehicles.

### RELEVANT PRIOR ART

In Ng and Farkas PCT Patent Application No. CA94/00667 filed Dec. 7, 1994 (the disclosure of which is hereby incorporated herein by reference), there is disclosed a heat-sealable polyamide film which may be used in multilayered structures for use in packaging. Generally these polyamides comprise at least one pendant alkyl branch having 1 to 3 carbon atoms within at least two amide linkages along the polymer backbone and at least one sequence of at least seven consecutive carbon atoms, excluding carbon atoms in pendant alkyl branches, if any, within at least two amide linkages along the polymer backbone. Specifically, they are referred to as low temperature Nylons (LTN).

In Saltman, U.S. Pat. No. 5,091,478 issued Feb. 25, 1992 (the disclosure of which is hereby incorporated herein by reference), there are disclosed partially grafted flexible thermoplastic compositions formed by melt blending under high shear, a thermoplastic material having available graft sites, said thermoplastic material being at least one continuous phase of the composition, an ethylene copolymer containing an unsaturated mono-carboxylic acid, and a polymeric grafting agent having reactive groups capable of reacting with the mono-carboxylic acid in the ethylene copolymer and with the available graft sites in the thermoplastic material. These compositions have use in a wide range of molding, coating and adhesive applications, including various automotive applications, wire and cable coating applications and high temperature adhesive applications.

In Epstein, U.S. Pat. No. 4,174,358 issued Nov. 13, 1979, there is disclosed toughened multi-phase thermoplastic compositions consisting of essentially one phase containing 60 to 99 percent by weight of a polyamide matrix resin of number average molecular weight of at least 5000, and 1 to 40 percent by weight of at least one other phase containing particles of at least one polymer having a particle size in the range of 0.01 to 3.0 microns and being adhered to the polyamide, the at least one polymer having a tensile modulus in the range of 1.0 to 20,000 p.s.i., the ratio of the tensile modulus of the polyamide matrix to tensile modulus of said at least one polymer being greater than 10 to 1. The polymer is either branched or straight chain, but the nylon is conventional nylon. The toughened polymer is useful for making molded and extruded parts.

Typical polyamides, such as Nylon 6 and Nylon 66, do not possess an adequate combination of thermal stability, formability and heat-sealability for commercially making embossed laminated structures. This is especially true when these polymers are first made into film, and then fed to an embossing and laminating process.

### SUMMARY OF THE INVENTION

It has now been found that the basic formulation covered by the Saltman patent possesses the right combination of high temperature thermal stability, formability and heat stability to permit the manufacture of resins and films for use in the heat shielding applications described previously. The addition of LTN significantly improves heat sealability and formability of the formulation. Other embodiments of the formulation include elimination of the polymeric grafting agent, the addition of other tougheners, and increased levels of the conventional polyamides as claimed in the Saltman patent.

Thus, the invention provides a variety of formulations, based on the basic Saltman formulation which exhibit properties which make the resultant resins and films useful in the types of applications envisaged earlier.

Uses of the present formulations may extend to packaging and cushioning applications where high temperature properties are desirable, for example in stoves, furnaces, aircraft and so forth.

The term “Graft Sites” as used in connection with the polyamide resin of component i) hereinafter set out is meant to encompass the reactive sites on the polyamide. These can be at the end of the molecule (amine or carboxyl ends) or on the backbone (amide linkages).

The present films approach polyethylene films with respect to heat sealability, but their thermal stability is higher than polyolefin films. In addition, the heat sealing temperature window and forming window are sufficiently broad to permit their use in many commercial applications. One important such application is in bubble pack structures for heat-shielding applications in automobiles, as noted. Typically, the film for such use would pass an oven test at 200° C. for one hour.

The present invention provides a heat formable laminating film made from a multi-phase thermoplastic resin composition comprising the following main components:

i) at least one polyamide resin selected from aliphatic and semi-aromatic polyamides that can be either semi-crystalline or amorphous in structure having a number average molecular weight of at least about 5000, having graft sites and forming the continuous phase of the composition, wherein any semi-crystalline polyamides have a melting point greater than 200° C.;

ii) at least one polyamide resin comprising at least one pendant alkyl branch having 1 to 3 carbon atoms within at least two amide linkages along the polymer backbone and at least one sequence of at least seven consecutive carbon atoms, excluding carbon atoms in pendant alkyl branches, if any, within at least two amide linkages along the polymer backbone, the melting point of the polyamide being less than 200° C., having graft sites and also forming the continuous phase of the composition, wherein the semi-crystalline polyamides have a melting point greater than 200° C.

iii) at least one ethylene copolymer, E/X/Y, where E is ethylene and is at least about 50% by weight of E/X/Y, X is from about 1to about 35% by weight of an acid containing unsaturated mono-carboxylic acid, and Y is 0 to about 49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms, and further wherein the acid groups in the acid-containing moiety are neutralized from 0 to about 100% by weight of a metal ion;

iv) at least one polymeric grafting agent which contains reactive groups selected from at least one of epoxides, isocyanates, aziridines, silanes, alkyl halides, alpha-halo ketones and aldehydes, or oxazoline, which reacts with the acid-containing moieties in component iii) and additionally reacts with the graft sites of components i) and ii), and the weight percent of the monomer(s) containing the reactive groups is about 0.5 to about 15 weight percent of the polymeric grafting agent, and the remainder of the polymeric grafting agent contains at least about 50% by weight of ethylene and from 0 to about 49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms; and

v) at least one C₂-C₂₀ polyolefin selected from polyethylene, polypropylene, ethylene propylene diene terpolymer, copolymers of ethylene with vinyl acetate, carbon monoxide, or ethylenically unsaturated carboxylic acids or esters thereof upon which are grafted from about 0.05 to about 5% by weight of monomers or mixtures of monomers selected from ethylenically unsaturated acidic monomers or their derivatives including acrylic acid, methacrylic acid, maleic acid, fumaric acid, itaconic acid, crotonic acid, 5-norborene-2,3-dicarboxylic acid, maleic anhydride, monomethyl fumarate and monomethyl maleate; and from ethylenically unsaturated monomers containing amino or hydroxy functional groups including vinyl pyridines, vinyl silanes, 4-vinyl pyridine, vinyltriethyloxysilane and allyl alcohol; the components being combined in accordance with one of the following formulation combinations:

A. from about 29 to about 54% by weight of component i), from about 8 to about 70% by weight of component iii), and from about 0.8 to about 45% by weight of component iv);

B. from about 17 to about 54% by weight of component i), from about 1 to about 40% by weight of component ii), from about 5 to about 69% by weight of component iii), and from about 0.5 to about 45% by weight of component iv); such that the sum of components i) and ii) equals from about 29 to about 72% by weight;

C. from about 55 to about 90% by weight of component i), from about 10 to about 45% by weight of components iii) or v) or mixtures thereof;

D. from about 15 to about 89% by weight of component i), from about 1 to about 40% by weight of component ii), from about 10 to about 45% by weight of component iii) or v) or mixtures thereof; and such that the sum of components i) and ii) equals from about 55 to about 90% by weight;

E. from about 30 to about 91% by weight of component i), from about 1.5 to about 70% by weight of component iii), and from about 0.15 to about 45% by weight of component iv).

It should be noted that each of the above formulations A to E may be used to prepare film to make the heat formable laminating film of the invention.

In another embodiment of the invention there is provided a novel multi-phase resin composition comprising as the main components:

from about 17 to about 54% by weight of (i) at least one polyamide resin selected from aliphatic and semi-aromatic polyamides that can be either semi-crystalline or amorphous in structure having a number average molecular weight of at least about 5000, having graft sites and forming the continuous phase of the composition, wherein the semi-crystalline polyamides have a melting point greater than 200° C.;

from about 1 to about 40% by weight of (ii) at least one polyamide resin comprising at least one pendant alkyl branch having 1 to 3 carbon atoms within at least two amide linkages along the polymer backbone and at least one sequence of at least seven consecutive carbon atoms, excluding carbon atoms in pendant alkyl branches, if any, within at least two amide linkages along the polymer backbone, the melting point of the polyamide being less than 200° C., having graft sites and also forming the continuous phase of the composition; and with the proviso that the sum of components i) and ii) is from about 29 to v 72% by weight;

from about 5 to about 69% by weight of (iii) at least one ethylene copolymer, E/X/Y, where E is ethylene and is at least about 50% by weight of E/X/Y, X is from about 1to about 35% by weight of an unsaturated mono-carboxylic acid, and Y is 0 to about 49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms, and further wherein the acid groups in the acid-containing moiety are neutralized from 0 to about 100% by weight of a metal ion; and

from about 0.5 to about 45% by weight of (iv) at least one polymeric grafting agent which contains reactive groups selected from at least one of epoxides, isocyanates, aziridines, silanes, alkyl halides, alpha-halo ketones and aldehydes, or oxazoline, which grafting agents react with the acid-containing moieties in component iii) and additionally react with the graft sites of components i) and ii), and the weight percent of the monomer(s) containing the reactive groups is about 0.5 to about 15 weight percent of the polymeric grafting agent, and the remainder of the polymeric grafting agent contains at least about 50% by weight of ethylene and from 0 to about 49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms.

Yet another embodiment is directed to a novel multi-phase resin composition comprising as the main components:

from about 15 to about 89% by weight of (i) at least one polyamide resin selected from aliphatic and semi-aromatic polyamides that can be either semi-crystalline or amorphous in structure having a number average molecular weight of at least about 5000, having graft sites and forming the continuous phase of the composition, wherein the semi-crystalline polyamides have a melting point greater than 200° C.;

from about 1 to about 40% by weight of (ii) at least one polyamide resin comprising at least one pendant alkyl branch having 1 to 3 carbon atoms within at least two amide linkages along the polymer backbone and at least one sequence of at least seven consecutive carbon atoms, excluding carbon atoms in pendant alkyl branches, if any, within at least two amide linkages along the polymer backbone, the melting point of the polyamide being less than 200° C., having graft sites and also forming the continuous phase of the composition, wherein the semi-crystalline polyamides have a melting point greater than 200° C. and with the proviso that the total of components i) and ii) is from about 55 to about 90% by weight; and

from about 10 to about 45% by weight of (iii) at least one ethylene copolymer, E/X/Y, where E is ethylene and is at least about 50% by weight of E/X/Y, X is from about 1 to about 35% by weight of an acid containing unsaturated mono-carboxylic acid, and Y is 0 to about 49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms, and further wherein the acid groups in the acid-containing moiety are neutralized from 0 to about 100% by weight of a metal ion; or

from about 10 to about 45% by weight of (v) at least one C₂-C₂₀ polyolefin selected from polyethylene, polypropylene, ethylene propylene diene terpolymer, copolymers of ethylene with vinyl acetate, carbon monoxide, or ethylenically unsaturated carboxylic acids or esters thereof upon which are grafted from about 0.05 to about 5% by weight of monomers selected from ethylenically unsaturated acidic monomers or their derivatives including acrylic acid, methacrylic acid, maleic acid, fumaric acid, itaconic acid, crotonic acid, 5-norborene-2,3-dicarboxylic acid, maleic anhydride, monomethyl fumarate and monomethyl maleate; and from ethylenically unsaturated monomers containing amino or hydroxy functional groups including vinyl pyridines, vinyl silanes, 4-vinyl pyridine, vinyltriethyloxysilane and allyl alcohol; or mixtures of iii) and v), in any desired ratio.

In a preferred form of the invention, the ends balance of the low temperature nylon has been found to affect the processing and properties of the final film product. In other words, it has been found that low temperature nylon, specifically D12, with balanced or carboxyl rich ends in the formulation reduces filter pressure drops and melt viscosities during film production, and improves film dimensional stability during heating—compared to the incorporation of D12 having amine-rich ends.

A most preferred form of the present formulation comprises from about 17 to about 54% by weight, more preferably, from about 18 to about 47% by weight, and most preferably, from about 19 to about 40% by weight of Nylon 6 (component i); from about 1 to about 40% by weight, more preferably about 10 to about 40% by weight; most preferably from about 20 to about 40% by weight of Nylon D12 (low temperature nylon), (component ii); from about 5 to about 69%, more preferably from about 11 to about 58% by weight, and most preferably from about 15 to about 48% by weight of ethylene E/X/Y (component iii); from about 0.5 to about 45% by weight, more preferably from 2 to 28%, most preferably from about 3 to about 16% by weight of ethylene/n-butyl acrylate/glycidyl methacrylate (component iv); with the total amount of nylon ranging preferably from about 29 to about 72% by weight, more preferably from about 38 to about 71% by weight, and most preferably from about 45 to about 70% by weight.

It should be noted that for the ranges set out above these may be applied to the various generic components also.

In another preferred form of the invention, the formulation B comprises from about 55 to about 80% by weight of components (i) and (ii), with the nylon component always in the majority (the SURLYN® and ethylene/n-butyl acrylate/glycidyl methacrylate components are in the minority), but component (i) may range from about 20 to about 60% by weight, and component (ii) may range from about 10 to about 35% by weight.

In every instance, the formulations disclosed herein may include antioxidants, heat stabilizers or mixtures thereof. Typically these comprise from about 0.05 to about 5.0% by weight, preferably from about 0.05 to about 2.0% by weight. Organic heat stabilizers have been found to be better than the metal halide heat stabilizers, such as Cul/KI, in terms of retention of film physical properties after oven aging for one hour at 200° C. Irganox® 1010/1098 is a preferred example of such a material. This substance also reduces filter pluggage and reduces pressure during the production of the film.

Other optional ingredients may be selected from flame retardants, anti-blocking agents, slip additives, pigments or dyes, processing aids, plasticizers and ultra-violet blocking agents. These may be used in suitable quantities as are well known to those skilled in the art.

All of the resin formulations set forth above may be formed into films using well known techniques in the art. Such films form part of the novel aspects of the present invention with respect to the novel resin formulations noted above. It is to be understood that the terms layer, sheet, and film are used interchangeably herein. The term layer may encompass monolayer and multilayer films as well.

The invention also provides an embossed laminate formed from the above multi-phase composition. It comprises an embossed layer of the composition heat sealed to an unembossed layer of the same or similar composition.

In another aspect the invention provides a high temperature heat shield assembly comprising at least one layer of embossed laminate as described above, having adhered thereto at least one layer of a reflective material. The assembly may comprise a plurality of layers arranged in suitable sequence to produce a heat shield effect, with at least one reflective layer as an exterior layer and at least one embossed laminate layer as an interior layer. The layers of such an assembly are usually adhered by means of suitable high temperature adhesives, well known to those skilled in the art.

Cushioning and protective assemblies may be constructed in a similar fashion to the heat shielding assemblies described above.

In yet another aspect the invention provides a method for producing a heat formed, flexible, thermoplastic, embossed laminate, wherein a resin is formed by blending the components of one of the formulations described above, and the resin is extruded, passed through a die and immediately into an embossing and laminating process.

In a final aspect, the invention provides a method for producing a heat formed, flexible, thermoplastic, embossed laminate, wherein a resin is formed by blending the components of one of the formulations described above, and the resin is extruded and passed though a die to form a film or sheet or layer which is subsequently subjected to an embossing and laminating process.

The embossed laminate is manufactured in accordance with known methods and equipment for manufacturing such materials. An example of both a suitable method and apparatus is described in Fielding U.S. Pat. No. 3,586,565 issued Jun. 22, 1971, the disclosure of which is hereby incorporated by reference. The bosses or cells are generally closed to provide insulating value and may be of any suitable shape, with bubbles, diamonds, squares and the like being examples of typical shapes.

When the embossed laminated film is prepared using film that has been stored the film is pre-heated prior to the embossing and laminating steps.

A typical insulating structure for use in a heat shield application, such as in motor vehicles comprises at least one layer of the present embossed laminate adhered to at least one layer of a reflective layer. The reflective layer may be selected from any number of materials suitable for this purpose. Examples include metal foil and sheet metal. Alternatively, thin metal layers may be applied to the film surface by standard metallization techniques such as vacuum deposition.

In alternative applications where high temperature requirements are not of concern, the structure may comprise at least one embossed laminate film layer as described above and at least one layer selected from wood, paper, and synthetic plastics.

A typical high temperature heat insulating structure is found in the following tabular illustration.

TABLE 1

| | | | | | | |
|---|---|---|---|---|---|---|
| Metal | Adhesive | Embossed | Center | Embossed | Adhesive | Metal layer - |
| layer - | (high | laminate | film layer, | laminate | (high | Reflective |
| Reflective | temperature) | bosses | optionally | | temperature) | Layer |
| Layer | | | coated | | | |
| | | | with | | | |
| | | | adhesive | | | |
| | | | on both | | | |
| | | | sides | | | |

The film used to make the laminate of this invention is typically from about 25 microns to about 102 microns thick(1 to about 4 mils). The reflective layer is typically about 76 microns (3 mils) thick. The films, sheets, layers of the formulations of this invention may range in thickness from about 25 to about 508 microns (1 to about 20 mils), preferably from 12.7 to about 254 microns (about 0.5 to about 10 mils), and most preferably about 25 to about 102 microns (1 to about 4 mils) thick (the last as stated above).

It is also possible to replace one of the outer metal layers with a non-reflective layer, such as paper, wood, synthetic plastics material or any other suitable material.

In the following five tables there are set out the various combinations of components that may comprise the five different combinations set out earlier as being capable of being heat formed into embossed laminates. These tables set out the broad ranges for the components already described and include the preferred and most preferred combinations of components. It will be apparent, from the earlier description that there are two types of formulations which are novel, these are those found in Table III of Formulation B and Table V of Formulation D. Each of these contains the LTN component.

TABLE II
Formulation A

| | Broadest | Preferred | Most Preferred |
|---|---|---|---|
| | Formulation | Formulation | Formulation |
| | Ranges % By | Ranges % By | Ranges % By |
| | Weight Based | weight Based | Weight Based |
| | on Total of | on Total of | on Total of |
| | Main Compo- | Main Compo- | Main Compo- |
| | nents (About | nents (About | nents (About |
| | prefaces | prefaces each | prefaces each |
| Component | each Number) | Number) | Number) |
| Component i | 29-54 | 31-52 | 32-50 |
| Polyamide | | | |
| Component i | ≧5000 | ≧7500 | ≧10000 |
| Polyamide | | | |
| Number Average | | | |
| Molecular Weight | | | |
| Component iii | 8-70 | 18-65 | 25.5-60 |
| Ethylene Copolymer | | | |
| E/X/Y | | | |
| Component iii | ≧50 | ≧55 | ≧60 |
| % E | | | |
| Component iii | 1-35 | 3-30 | 5-15 |
| % X | | | |
| Component iii | 0-49 | 0-35 | 0-25 |
| % Y | | | |
| Component iii | 0-100 | 0-80 | 0-75 |
| % Neutralization of | | | |
| Acid Groups in X by | | | |
| Metal Ion | | | |
| Component iv | 0.8-45% | 3-30.5 | 5-20.5 |
| Polymeric Grafting | | | |
| Agent | | | |
| Component iv | 0.5-15 | 1-10 | 1-7 |
| Polymeric Grafting | | | |
| Agent | | | |
| % by Weight of | | | |
| Monomers | | | |
| Containing Reactive | | | |
| Groups as % By | | | |
| Weight of Polymeric | | | |
| Grafting Agent | | | |
| Component iv | ≧50 | ≧55 | ≧60 |
| Polymeric Grafting | | | |
| Agent | | | |
| % By Weight | | | |
| Ethylene | | | |
| Component iv | 0-49 | 0-35 | 0-35 |
| Polymeric Grafting | | | |
| Agent | | | |
| % By Weight Alkyl | | | |
| Moiety | | | |

TABLE III
Formulation B

| | Broadest | Preferred | Most Preferred |
|---|---|---|---|
| | Formulation | Formulation | Formulation |
| | Ranges % By | Ranges % By | Ranges % By |
| | Weight Based | weight Based | Weight Based |
| | on Total of | on Total of | on Total of |
| | Main Compo- | Main Compo- | Main Compo- |
| | nents (About | nents (About | nents (About |
| | prefaces each | prefaces each | prefaces each |
| Component | Number) | Number) | Number) |
| Component i | 17-54^{a} | 20-49^{b} | 22-45^{c} |
| Polyamide | | | |
| Component i | ≧5000 | ≧7500 | ≧10000 |
| Polyamide | | | |
| Number Average | | | |
| Molecular Weight | | | |
| Component ii | 1-40^{a} | 5-35^{b} | 10-30^{c} |
| Polyamide | | | |
| Component iii | 5-69 | 12-62 | 18-54 |
| Ethylene | | | |
| Copolymer E/X/Y | | | |
| Component iii | ≧50 | ≧55 | ≧60 |
| % E | | | |
| Component iii | 1-35 | 3-30 | 5-15 |
| % X | | | |
| Component iii | 0-49 | 0-35 | 0-25 |
| % Y | | | |
| Component iii | 0-100 | 0-80 | 0-75 |
| % Neutralization of | | | |
| Acid Groups in X by | | | |
| Metal Ion | | | |
| Component iv | 0.5-45% | 2-29 | 3.5-18 |
| Polymeric Grafting | | | |
| Agent | | | |
| Component iv | 0.5-15 | 1-10 | 1-7 |
| Polymeric Grafting | | | |
| Agent | | | |
| % by Weight of | | | |
| Monomers | | | |
| Containing | | | |
| Reactive Groups as | | | |
| % By Weight of | | | |
| Polymeric Grafting | | | |
| Agent | | | |
| Component iv | ≧50 | ≧55 | ≧60 |
| Polymeric Grafting | | | |
| Agent | | | |
| % By Weight | | | |
| Ethylene | | | |
| Component iv | 0-49 | 0-35 | 0-35 |
| Polymeric Grafting | | | |
| Agent % By Weight | | | |
| Alkyl Moiety | | | |

^{a)}i + ii = 27-72, ^{b)}i + ii = 34-69, ^{c)}i + ii = 39-65

TABLE IV
Formulation C

| | Broadest | Preferred | Most Preferred |
|---|---|---|---|
| | Formulation | Formulation | Formulation |
| | Ranges % By | Ranges % By | Ranges % By |
| | Weight Based | weight Based | Weight Based |
| | on Total of | on Total of | on Total of |
| | Main Compo- | Main Compo- | Main Compo- |
| | nents (About | nents (About | nents (About |
| | prefaces each | prefaces each | prefaces each |
| Component | Number( | Number) | Number) |
| Component i | 55-90 | 60-80 | 60-75 |
| Polyamide | | | |
| Component i | ≧5000 | ≧7500 | ≧10000 |
| Polyamide | | | |
| Number | | | |
| Average | | | |
| Molecular | | | |
| Weight | | | |
| Component iii | 10-45 | 20-40 | 25-40 |
| Ethylene | | | |
| Copolymer | | | |
| E/X/Y or | | | |
| Component v | | | |
| (a grafted | | | |
| polyolefin), or | | | |
| mixtures | | | |
| thereof* | | | |
| Component iii | ≧50 | ≧55 | ≧60 |
| % E | | | |
| Component iii | 1-35 | 3-30 | 5-15 |
| % X | | | |
| Component iii | 0-49 | 0-35 | 0-25 |
| % Y | | | |
| Component iii | 0-100 | 0-80 | 0-75 |
| % Neutralization | | | |
| of Acid Groups | | | |
| in X by Metal | | | |
| Ion | | | |

*Any ratio may be used.

TABLE V
Formulation D

| | Broadest | Preferred | Most Preferred |
|---|---|---|---|
| | Formulation | Formulation | Formulation |
| | Ranges % By | Ranges % By | Ranges % By |
| | Weight Based | Weight Based | Weight Based |
| | on Total of | on Total of | on Total of |
| | Main Compo- | Main Compo- | Main Compo- |
| | nents (About | nents (About | nents (About |
| | prefaces each | prefaces each | prefaces each |
| Component | Number) | Number) | Number) |
| Component i | 15-89^{a} | 25-75^{b} | 30-65^{c} |
| Polyamide | | | |
| Component i | ≧5000 | ≧7500 | ≧10000 |
| Polyamide | | | |
| Number | | | |
| Average | | | |
| Molecular | | | |
| Weight | | | |
| Component ii | 1-40^{a} | 5-35^{b} | 10-30^{c} |
| Polyamide | | | |
| Component iii | 10-45 | 20-40 | |
| Ethylene | | | |
| Copolymer | | | |
| E/X/Y or | | | |
| Component v | | | |
| (a grafted | | | |
| polyolefin), or | | | |
| mixtures | | | |
| thereof | | | |
| Component iii | ≧50 | ≧55 | ≧60 |
| % E | | | |
| Component iii | 1-35 | 3-30 | 5-15 |
| % X | | | |
| Component iii | 0-49 | 0-35 | 0-25 |
| % Y | | | |
| Component iii | 0-100 | 0-80 | 0-75 |
| % Neutralization | | | |
| of Acid | | | |
| Groups in X | | | |
| by Metal Ion | | | |

^{a)}i + ii = 55-90, ^{b)}i + ii = 60-80, ^{c)}i + ii = 60-75

TABLE VI
Formulation E

| | Broadest | Preferred | Most Preferred |
|---|---|---|---|
| | Formulation | Formulation | Formulation |
| | Ranges % By | Ranges % By | Ranges % By |
| | Weight Based | weight Based | Weight Based |
| | on Total of | on Total of | on Total of |
| | Main Compo- | Main Compo- | Main Compo- |
| | nents (About | nents (About | nents (About |
| | prefaces each | prefaces each | prefaces each |
| Component | Number) | Number) | Number) |
| Component i | 30-91 | 32-76 | 32-65 |
| Polyamide | | | |
| Component i | ≧5000 | ≧7500 | ≧10000 |
| Polyamide | | | |
| Number Average | | | |
| Molecular Weight | | | |
| Component iii | 1.5-70 | 9-65 | 18-60 |
| Ethylene | | | |
| Copolymer E/X/Y | | | |
| Component iii | ≧50 | ≧55 | ≧60 |
| % E | | | |
| Component iii | 1-35 | 3-30 | 5-15 |
| % X | | | |
| Component iii | 0-49 | 0-35 | 0-25 |
| % Y | | | |
| Component iii | 0-100 | 0-80 | 0-75 |
| % Neutralization of | | | |
| Acid Groups in X by | | | |
| Metal Ion | | | |
| Component iv | 0.15-45 | 1.5-30 | 3.5-20 |
| Polymeric Grafting | | | |
| Agent | | | |
| Component iv | 0.5-15 | 1-10 | 1-7 |
| Polymeric Grafting | | | |
| Agent | | | |
| % by Weight of | | | |
| Monomers | | | |
| Containing | | | |
| Reactive Groups as | | | |
| % By Weight of | | | |
| Polymeric Grafting | | | |
| Agent | | | |
| Component iv | ≧50 | ≧55 | ≧60 |
| Polymeric Grafting | | | |
| Agent | | | |
| % By Weight | | | |
| Ethylene | | | |
| Component iv | 0-49 | 0-35 | 0-35 |
| Polymeric Grafting | | | |
| Agent | | | |
| % By Weight Alkyl | | | |
| Moiety | | | |

Component i)

The polyamide of component i) embraces those semi-crystalline and amorphous resins having a number average molecular weight of at least about 5000 and commonly referred to as nylons. Suitable polyamides include those described in U.S. Pat. Nos. 2,071,250; 2,071,251; 2,130,523; 2,130,948; 2,241,322; 2,312,966; 2,512,606; and 3,393,210. The polyamide resin can be produced by condensation of equimolar amounts of an aliphatic or aromatic dicarboxylic acid containing from 4 to 12 carbon atoms with a diamine, in which the diamine contains from 4 to 14 carbon atoms. Excess diamine can be employed to provide an excess of amine end groups over carboxyl end groups in the polyamide. Examples of polyamides include polyhexamethylene adipamide (Nylon 66), polyhexamethylene azelaamide (Nylon 69), polyhexamethylene sebacamide (Nylon 610), and polyhexamethylene dodecanoamide (612 Nylon), the polyamide produced by ring opening of lactams, i.e., polycaprolactam, polylauric lactam, poly-11-aminoundecanoic acid, bis(paraaminocyclohexyl) methane dodecanoamide. It is also possible to use in this invention polyamides prepared by the copolymerization of two of the above polymers or terpolymerization of the above polymers or their components, e.g., 6T/DT, a copolymer of terephthalic acid (T) and 2-methylpentamethylenediamine (D) and hexamethylenediamine (6). Preferably the polyamides are semi-crystalline and aliphatic or semi-aromatic with a melting point in excess of 200° C., or they are amorphous.

Preferred polyamides include Nylon 66, Nylon 6, Nylon 612, Nylon 11, Nylon 12, Nylon 1212, amorphous nylons, Nylon 6/66 copolymers.

Most preferred polyamides include Nylon 66, Nylon 612 and Nylon 6.

It is to be understood that this component may comprise blends of two or more nylons.

Component ii)

The polyamides used in component ii) are best described as low temperature polyamides. Typically, they are prepared from

(a) at least one dicarboxylic acid and at least one diamine, wherein said dicarboxylic acid or said diamine or both contain at least one alkyl branch having one to three carbon atoms; and wherein said dicarboxylic acid or said diamine or both comprise at least seven methylene groups; or

(b) at least one alpha, omega aminocarboxylic acid, having the formula of H₂N—R(1)—COOH, in which R(1) is an aliphatic moiety having at least six methylene groups and at least one pendant alkyl branch having 1 to 3 carbon atoms, or

(c) at least one diamine and at least one nitrile selected from the group consisting of alpha omega amino alkylene nitrites and alpha omega alkylene dinitriles, wherein said diamine or said nitrile or both contain at least one alkyl branch having one to three carbon atoms; and wherein said diamine or said nitrile or both comprise at least seven methylene groups; or

(d) mixtures of any of the monomers described in (a)-(c) above.

Examples of the diamines include 1,6 hexamethylene diamine; 1,8 octamethylene diamine; 1,10 decamethylene diamine and 1,12-dodecamethylene diamine. Examples of a branched diamine include 2-methyl-pentamethylene diamine, but other branched diamines having C1-C3 alkyl branches may be used.

Examples of the dicarboxylic acids include 1,6-hexanedioic acid (adipic acid); 1,7-heptanedioic acid (pimelic acid); 1,8-octanedioic acid (suberic acid); 1,9-nonanedioic acid (azelaic acid); 1,10-decanedioic acid (sebacic acid) and 1,12-dodecanedioic acid. Examples of branched dicarboxylic acids include 2-methyl glutaric acid, but other branched dicarboxylic acids having C₁-C₃ alkyl branches may be used.

D12 is a homopolymer of 2-methylpentamethylene diamine and dodecanedioic acid. The copolymer of D12/612 is a copolymer of 2-methylpentamethylene diamine, hexamethylene diamine and dodecanedioic acid. These represent preferred nylon choices. Examples of alpha, omega amino carboxylic acids are aminocaproic acid, amino octanoic acid, amino decanoic acid, amino undecanoic acid and aminododecanoic acid. It should be noted that the aminocarboxylic acid may be in the form of a lactam, especially when the aliphatic moiety has six methylene groups. Examples of branched alpha, omega amino carboxylic acids are 2-methyl-amino dodecanoic acid and 2-methyl-amino decanoic acid although others may be used.

Examples of the nitriles are 1,5 aminocapronitrile, adiponitrile, 1,11-amino undecanonitrile, 1,10-amino decanodinitrile and 2-methyl-1,11-amino undecanonitrile although others may be used.

In addition to monomers (a)-(c) listed herein, other monomers may be used to prepare the polyamides of the present invention. These other monomers include, but are not limited to, aromatic dicarboxylic acids, aromatic diamines, alicyclic dicarboxylic acids, and alicyclic diamines. Examples of aromatic dicarboxylic acids include terephthalic and isophthalic acids. An example of an alicyclic dicarboxylic acid is 1,4-bismethylene cyclohexyl dicarboxylic acid. An example of an alicyclic diamine is 1,4-bismethylene diamino cyclohexane. When the polyamide is semi-crystalline, it is desirable that such polyamide exhibit a melting point less than 200° C. and a broad melting profile, which is herein defined as the range of temperature from the onset of the melting curve in a differential scanning calorimetry (DSC) test to the maximum melting peak that is measured, of greater than about 45° C.

The polyamides may be manufactured using processes well known in the art. In particular the polyamides may be polymerized from salts of the diamine and dicarboxylic acid. Alternatively, the polyamides may be polymerized using the corresponding nitriles, as discussed above.

The polyamide may be in the form of a homopolymer polymerized from one diamine and one dicarboxylic acid, an aminocarboxylic acid, an amino alkyl nitrile, or one diamine and a dinitrile. Alternatively, the polyamide may be a copolymer polymerized from at least one diamine with more than one dicarboxylic acid or at least one dicarboxylic acid with more than one diamine or a combination of at least one diamine, at least one dicarboxylic acid and at least one aminocarboxylic acid, optionally containing nitriles. The copolymer preferably contains at least about 20 mole percent of branched moieties, more preferably at least about 30 mole percent and most preferably at least about 50 mole percent of branched moieties, based on the total amount of the aliphatic moieties in the polyamide.

In preferred embodiments of the present invention, the polyamide, when semi-crystalline, has a melting point of less than 200° C., more preferably between about 120° C. to about 180° C., and most preferably between about 140° C. to about 180° C. It is also preferred that the polyamide has a broad melting profile of greater than about 45° C., preferably greater than about 50° C., and most preferably greater than about 55° C.

Component iii)

Suitable ethylene copolymers include ethylene/acrylic acid, ethylene/methacrylic acid, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/ethyl vinyl ether, ethylene/methacrylic acid/butyl vinyl ether ethylene/acrylic acid/-methyl acrylate, ethylene/methacrylic acid/methyl acrylate, ethylene/methacrylic acid/methyl methacrylate, ethylene/acrylic acid/n-butyl methacrylate, ethylene/methacrylic acid/ethyl vinyl ether and ethylene/acrylic acid/butyl vinyl ether.

Preferred ethylene copolymers that contain a monocarboxylic acid moiety for use in the compositions of the present invention include ethylene/methacrylic acid, ethylene/acrylic acid, ethylene/methacrylic acid/n-butyl acrylate, ethylene/acrylic acid/n-butyl acrylate, ethylene/methacrylic acid/methylacrylate and ethylene/acrylic acid/methylacrylate copolymers. The most preferred ethylene copolymers for use in the compositions of the present invention are ethylene/methacrylic acid, ethylene/acrylic acid copolymers, ethylene/methacrylic acid/n-butyl acrylate and ethylene/methacrylic acid/methylacrylate terpolymers.

Surlyn® is an example of a suitable commercially available product. Zinc-neutralized Surlyn® is preferred for nylon over sodium-neutralized Surlyn®.

Component iv)

These polymeric grafting agents include ethylene copolymers copolymerized with monomers containing one or more reactive moieties said monomers selected from unsaturated epoxides of 4-11 carbon atoms, such as glycidyl acrylate, glycidyl methacrylate, allyl glycidyl ether, vinyl glycidyl ether, and glycidyl itaconate, unsaturated isocyanates of 2-11 carbon atoms, such as vinyl isocyanate and isocyanato-ethyl methylacrylate, aziridine and monomers containing, silanes such as alkoxy or alkyl silanes, alkylating agents such as alkyl halides, or alpha-halo ketones or aldehydes or oxazoline, and the polymeric grafting agent may additionally contain an alkyl acrylate, alkyl methacrylate, carbon monoxide, sulfur dioxide and/or alkyl vinyl ether, where the alkyl groups contain 1-12 carbon atoms.

Preferred polymeric grafting agents for use in the compositions of the present invention include ethylene/glycidyl acrylate, ethylene/n-butyl acrylate/glycidyl acrylate, ethylene/methylacrylate/glycidyl acrylate, ethylene/glycidyl methacrylate, ethylene/n-butyl acrylate/glycidyl methacrylate and ethylene/methylacrylate/glycidyl methacrylate copolymers. The most preferred grafting agents for use in the compositions of the present invention are copolymers derived from ethylene/n-butyl acrylate/glycidyl methacrylate and ethylene/glycidyl methacrylate.

It should be noted that the level of reactive component e.g. glycidyl methacrylate will affect the degree of crosslinking with the nylon, and may be adjusted appropriately to the desired level as known by those skilled in the art.

Component v)

The graft monomers, and mixtures thereof, used to prepare the graft polymers can be selected from the group consisting of ethylenically unsaturated acidic monomers or their derivatives including acrylic acid, methacrylic acid, maleic acid, fumaric acid, itaconic acid, crotonic acid, 5-norbornene-2,3-dicarboxylic acid, maleic anhydride, monosodium maleate, disodium maleate, itaconic anhydride, citraconic anhydride, monomethyl fumarate and monomethyl maleate. Also, the graft monomers can be selected from ethylenically unsaturated monomers containing amino or hydroxy functional groups including vinyl pyridines, vinyl silanes, 4-vinyl pyridine, vinyltriethoxysilane and allyl alcohol. The grafting monomers, and mixtures thereof, can be present in the graft polymer in an amount of from 0.05 to 5% wt. and would be grafted onto a C₂-C₂₀ polyolefin including polyethylene, polypropylene, ethylene propylene diene terpolymer, as well as copolymers of ethylene with, but not limited to, vinyl acetate, carbon monoxide, or ethylenically unsaturated carboxylic acids or esters thereof.

This component acts as an alternative toughener in the formulation. Grafted polyethylene, grafted polypropylene, and grafted rubber, may be used as noted earlier, and these may be used in combination with non-grafted polyethylenes, polypropylenes and rubbers. This component may be used interchangeably with component iii) in Formulations C and D as noted before in this disclosure.

Film Formation

The heat-sealable polyamide film may be formed by a cast film process or by a blown film process. Both types of film processes are known in the art of manufacture of polyamide films. Furthermore, the film may be a monolayer film or a multilayer film, the film being for example a coextruded film or a laminate. Either the monolayer film or the coextruded film may be in an unoriented condition, in the form of monoaxially oriented film or in the form of biaxially oriented film. It will be understood by persons skilled in the art that the properties of such polyamide films will depend on several factors including, but not limited to, extruder hold-up time and screw design, melt processing temperature, quenching rate and degree of quenching, film thickness, the amount of and type of additional components, as well as the amount of and type of the particular polyamide as described herein.

The polyamide resins described herein may also be coextruded or laminated with polyolefins or grafted polyolefin, particularly polyethylene, grafted polyethylene or grafted polypropylene, especially using tie or adhesive layers between the polyamide and polyolefin. The heat-sealable polyamide films may be laminated to polyolefins or other barrier polymers using conventional processes. In addition, the heat-sealable polyamides may be coated with polyvinylene dichloride (PVDC), EVOH, PVOH or other suitable barrier coatings and then laminated to itself to form a higher barrier heat-sealable structure.

Blending of Formulation Component

The compositions of the present invention, especially when in the form of layers e.g. films or sheets, may be treated with a corona discharge (ED) in order to improve the properties of the resins with respect to bonding of coatings, inks, adhesives or the like. In addition, the resins may contain additives such as, but not limited to, moisturizing agents, heat stabilizers, flame retardants, fillers, anti-blocking agents, slip additives, pigments or dyes, processing aids, anti-oxidants, plasticizers or ultra violet blocking agents. The components described above are melt blended with each other under high shear. The various ingredients may first be combined with one another in what is commonly referred to as a “salt and pepper” blend, i.e., a pellet blend, of each of the ingredients, or they may be combined with one another via simultaneous or separate metering of the various components, or they may be divided and blended in one or more passes into one or more sections of mixing equipment such as an extruder, Banbury, Buess Kneader, Ferrell continuous mixer, or other mixing equipment. For example, one can use an extruder with two or more feed zones into which one or more of the ingredients may be added sequentially. In this case, it is sometimes advantageous that the thermoplastic and polymeric grafting component be combined first, then the acid-containing copolymer be added downstream. This helps promote the grafting reaction(s) between the thermoplastic and polymeric grafting components, prior to the reaction(s) between the polymeric grafting component and acid-containing copolymer. However, the order of addition is such that the components (iii) and (iv) would never be added to the extruder without the nylon, as otherwise, a crosslinked non-extrudable material would result. The high shear insures proper dispersion of all the components such as would be necessary to carry out the grafting reaction. In addition, sufficient mixing is essential to achieve the morphology which is necessary in the compositions of the present invention. The morphology required for the compositions of the present invention is that at least one of continuous phases must be the thermoplastic, i.e., component i)., optionally also ii). Note that the thermoplastic, component i., optionally ii)., is at least one of the continuous phases in all of the compositions of the present invention even though the thermoplastic, component i)., optionally ii)., comprises less, and in fact, in many cases substantially less than 50 volume %. The addition of polyamides (a) and (b) forms one phase, so the combined polyamide phase should be preferred as the continuous phase.

In the following examples, there are described embodiments of the invention, which are for illustrative purposes only. These should not be used to limit the scope of the appended claims.

Examples

1. Test Methods:

1.1. Bubble Formability:

A skin packaging machine made by Sergeant, called a 1218 Packsafe, was modified to allow for evaluation of bubble formability. A metal perforated plate was installed on the surface of the skin-packaging base, allowing the vacuum holes to pull heated film into these perforations. The perforated metal sheet is 45.7 cm (18 inches) by 30.5 cm (12 inches) by 0.48 cm (3/16 inches) deep. The holes are 0.95 cm (⅜ inches) in diameter, and are staggered at 60 degree angles. The holes are spaced 1.43 cm (9/16 inch) apart, center to center.

The three variable cycle settings on the Packsafe machine are the “preheat”, “heat-hold” and “vacuum” cycles. The film is placed in a moveable frame and raised to about 6.35 cm (2.5 inches) away from a series of overhead IR heaters. During the period known as the “preheat”, the film is heated by IR wires for a given period of time. Then the cage is lowered onto the perforated plate as vacuum is being drawn through the holes in the perforated plate. This period is known as the “heat-hold”. Finally, the heated film is pulled into the holes in the perforated plate by the applied vacuum for a given period of time (IR heaters now turned off) called the “vacuum cycle”.

In addition, the amount of vacuum drawn through the holes in the perforated plate can also be altered, going from about 20 mm Hg up to 140 mm Hg.

The ability of the film to form bubbles is rated on a scale of 0 to 4:

0=no forming of film into the cavity of the perforated plate

1=shallow forming of film into cavity

2=intermediate forming of film into cavity

3=partial deep forming of film into cavity—part of the film has bottomed out on the floor of the cavity hole

4=complete deep forming of film into cavity—the entire floor of the formed film has bottomed out onto the floor of the cavity hole, and impressions of the vacuum holes are present.

Each bubble was individually rated, then the ratings were averaged for each film surface evaluated.

1.2. Heat-Sealability (Self-adhesion):

The heat seals were obtained using a Sentinal Model 12 ASL/1 heat sealer, using the following conditions:

¼ second dwell time

⅛-inch (0.3175 cm) seal bar width

only upper jaw heated (continuous heating)

275.8 KPa (40 psi) jaw pressure

The temperature during heat-sealing was measured by the thermocouple embedded in the upper jaw, and thus is referred to as “jaw temperature”.

Three pre-heat cycles (jaw closures) were done to pre-heat the lower jaw prior to the heat seal test. The heat sealed samples were cut having a width of 1.0 inches (2.54 cm), and tested on an Instron (Model 4204) having a crosshead speed of 20 inches (50.8 cm) per minute and having a grip distance of 2 inches (5.08 cm).

It is understood that heat seal and hot tack can be measured on any commercially available heat-sealer. In the determination of minimum heat-seal temperatures described herein; the minimum heat seal strength measurable on the apparatus used was about 30 g/cm. It is also understood that the actual temperature at the heat-seal interface will be lower than the actual temperature, the difference depending on the heat-seal conditions and the type of heat-seal machine used.

1.3. Thermal Stability:

Thermal stability is measured by placing the film under test in a hot-air oven, and heating the film for one hour at 200 deg C. A visual and manual inspection of the film was done after the oven heating to see if the film had melting or become embrittled.

### EXAMPLES

### Example 1

Pellets of Zytel FN® 726 were melt extruded in a 2.54 cm Killion single screw extruder, having an L/D of 24:1, at a melt processing temperature of 233 to 239 deg C. using a 120/60/80 mesh filter pack. The extrudate was extruded through a 5 cm diameter spiral blown film die having a die gap of 0.076 cm (30 mils).

Bubble formability, heat-sealability and thermal stability tests were conducted on these films. In addition, a commercially available LLDPE film, SCLAIR® A693, having a thickness of 51 microns, was also tested. A commercially available Nylon 6 film, having an RV (in formic acid) of about 70 and a thickness of 56 microns, was also tested. The results of bubble formability are shown in Table VII, and those of heat-sealability and thermal stability in Table VIII:

TABLE VII

| | Effective | Preheat | |
|---|---|---|---|
| | vacuum | time, | Bubble Formability |
| Film Type | level, mm Hg | seconds | (scale 0 to 4) |
| Zytel FN ® (Sample A) | 20 | 2.4 | 1.0 |
| | 20 | 19.7 | 4.0 |
| | 80 | 11.2 | 4.0 |
| | 140 | 2.4 | 1.0 |
| | 140 | 19.7 | 4.0 |
| Zytel FN ® (Sample B) | 20 | 2.4 | 1.0 |
| | 20 | 11.2 | 4.0 |
| | 20 | 19.7 | 4.0 |
| | 140 | 2.4 | 1.0 |
| | 140 | 19.7 | 4.0 |
| LLDPE | 20 | 2.4 | 0 |
| | 20 | 19.7 | 4.0 |
| | 80 | 11.2 | 3.0 |
| | 140 | 2.4 | 0 |
| | 140 | 19.7 | 4.0 |
| Nylon 6 | 20 | 2.4 | 0 |
| | 20 | 19.7 | 1.2 |
| | 80 | 11.2 | 0 |
| | 140 | 2.4 | 0 |
| | 140 | 19.7 | 1.0 |

Note:
the following cycle-time settings on the Packsafe machine were used:
Preheat Dial:
2.4 seconds = 0 dial setting
11.2 seconds = 95 dial setting
19.7 seconds = 200 dial setting
Heat-Hold Dial: 60 dial setting
Vacuum Dial: 2 seconds = 60 dial setting

It is assumed that the minimum acceptable bubble formability is 3. From the above, it can be seen that the Zytel FN® films have bubble formability characteristics similar to LLDPE, and that both pass this formability criteria. The Nylon 6 cannot form good bubbles.

TABLE VIII

| | | Temp. (C.) | Heat Seal | |
|---|---|---|---|---|
| | Heat Seal | at max. | maximum | |
| | Initiation | heat seal | strength | Film after oven |
| Film Type | Temp. (C.) | strength | (KPa) | heat aging |
| Zytel FN ® | 200 | 240 | 207 | Film retains good |
| | | | | toughness |
| LLDPE | 140 | 180 | 172 | Melted |
| Nylon 6 | 230 | 260 | 255 | Film brittle (not |
| | | | | heat-stabilized) |

It can be seen that Zytel FN ® film starts to heat-seal at a lower temperature than Nylon 6, and it also has a wider heat-sealing window.

### Example 2

“Salt and Pepper” blends (a dry pellet mixture) of various compositions were melt extruded in a 2.0 cm Welding Engineers twin-screw extruder, with non-intermeshing, counter-rotating screws, having an L/D of about 60. The melt was processed at one of 240° C., 260° C. or 280° C. using a 125 micron filter screen. A vacuum was applied to the vent port. The melt was extruded through a 15 cm flat film die having a die gap of 0.064 cm (25 mils). The extrudate was quenched on a chill roll set at a temperature of 30° C. to form a film having a thickness of about 51 microns. Bubble formability, heat-sealability and thermal stability tests were conducted on these films. In addition, comparison films made from Nylon 6 (BASF BS700A Nylon 6, with 50 RV) and Nylon 66 (50 RV in formic acid) were made. A commercially available Nylon 6 film, having an RV (in formic acid) of about 70 and a thickness of 56 microns, and a commercially available LLDPE film, SCLAIR® A693, having a thickness of 51 microns, were also tested for comparative purposes. The following blends as set out in Table IX were made into film:

TABLE IX

| | |
|---|---|
| Blend A | Zytel FN ® 727 (100% wt.) |
| Blend B | Zytel FN ® 727//Nylon 6 (75//25 blend ratio) |
| Blend C | Zytel FN ® 727//Nylon 6 (50//50 blend ratio) |
| Blend D | Nylon 6//g-PE//Surlyn ® 9320 (60//5//35 ratio) |
| Blend E | Nylon 6//g-PE//Surlyn ® 9520 (60//5//35 ratio) |
| Blend F | Nylon 6//Surlyn ® 9520 (60//40 blend ratio) |
| Comparative Film G | Nylon 6 (BASF BS700 A) |

Note:
the Zytel FN ® 727 and Blend D contain anti-oxidants and are heat-stabilized. However, none of the other components have been heat-stabilized, so the thermal stability tests are only useful for indicating whether the film would melt or not when placed in the oven for one hour at 200° C.

The results of bubble formability are given in Table X, while those of heat-sealability and oven heat-resistance are given in Table XI.

TABLE X

| | Melt Processing Temp., | Bubble Formability |
|---|---|---|
| Film Type | C. | (scale 0 to 4) |
| Blend A | 240 | 4.0 |
| Blend B | 240 | 3.9 |
| Blend D | 240 | 4.0 |
| Blend E | 240 | 4.0 |
| Blend F | 240 | 4.0 |
| Comp. Blend G | 240 | 2.0 |
| Blend A | 260 | 4.0 |
| Blend B | 280 | 4.0 |
| Blend C | 280 | 3.8 |
| Blend D | 280 | 4.0 |
| Comp. Blend G | 280 | 1.0 |
| Nylon 6 commercial | | 2.4 |
| film | | |
| LLDPE | | 4.0 |

Note:
the cycle-time settings on the Packsafe machine were as follows:
Preheat time: 11 seconds = 95 on the dial
Heat-hold: 1.3-1.4 seconds = 60 dial setting
Vacuum: 0.65-0.75 seconds = 20 dial setting, effective vacuum level = 120-130 mm Hg.

The minimum acceptable bubble rating is assumed to be 3. Using this criteria, the claimed blends all pass the forming criteria, as does the LLDPE film, while both the comparative Nylon 6 film and the commercially available Nylon 6 film do not pass this criteria.

TABLE XI

| | | | Heat Seal | |
|---|---|---|---|---|
| | Heat Seal | | maximum | Film after |
| | Initiation | Temp. (C.) at max. | strength | oven heat |
| Film Type | Temp. (C.) | heat seal strength | (KPa) | aging |
| Blend A | 270 | 290 | 12,770 | Pass |
| Blend B | 250 | 270 | 12,942 | |
| Blend D | 260 | 300 | 15,783 | Pass |
| Blend F | 250 | 270 | 2600 | Did not melt |
| LLDPE | 160 | 200-240 | 11,239 | Melted |
| Capran N6 | 250 | 280 | 11,087 | Did not melt |

It can be seen that the claimed blends are heat-sealable, and pass the oven test without melting, while LLDPE melted.

### Example 3

A “salt and pepper”, or dry blend, of the following composition was prepared.

Nylon 6 (BASF BS700A): 29.8% wt

D12 (RV=50): 29.8%

Surlyn®: 30.0%

Ethylene/N-Butyl Acrylate/Glycidyl Methacrylate (Elvalloy®): 10.0%

Anti-oxidant (Cul/KI/Alum. Distearate 7:1:0.5): 0.48%

Also, as a control, Zytel FN® 727 was also used, which is a partially grafted, multi-phase flexible thermoplastic composition.

The above two formulations were each separately melt extruded in a 53 mm W&P twin screw extruder at a melt processing temperature of 245° C. and using a 125 micron filter. The melt was extruded through a 122 cm flat film die. The extrudate was quenched on a chill roll set at a temperature of 31° C. to form a film having a thickness of 53 microns.

In the dry blend, the Nylon 6 component has a relative viscosity (in formic acid) of 50, while the D12 polymer has a relative viscosity (in formic acid) of 50.

A control for bubble formability and heat stability was also tested, which is a commercially available polyethylene/Nylon6/polyethylene coextrusion, this structure being 51 microns thick with the Nylon core layer being 5 microns thick.

Heat-seal, bubble formability and heat stability tests were carried out on these films. The results are as shown in Table XII.

TABLE XII

| Test | Dry Blend* | Zytel FN ® | Coex Control |
|---|---|---|---|
| Heat Sealability: | | | |
| Seal Initiation Temp. (Jaw | <200° C. | 240° C. | |
| temp.) ° C. | | | |
| Maximum Seal Temp. (Jaw | 260-280° C. | 260-280° C. | |
| Temp.) ° C. | | | |
| Maximum bond strength, | 2909 | 2454 | |
| g/in | | | |
| Bubble Formability (using | Excellent | Excellent | Excellent |
| modified Packsafe Skin | | | |
| Packaging machine) | | | |
| Heat Stability Test (one | | | |
| hour in hot air oven at | | | |
| 200° C.): | | | |
| % Elongation before heat- | 438 | 382 | 394 |
| aging: | | | |
| % Elongation after heat- | 253 | 374 | 3 |
| aging: | | | |
| Ultimate Tensile Stress | 50,975 | 38,005 | 31,483 |
| before heat-aging (KPa) | | | |
| Ultimate Tensile Stress | 29.835 | 38,440 | 6688 |
| after heat-aging: (KPa) | | | |

*Dry pellet mixture

One can see that both the “salt and pepper” blend (dry pellet blend) and the Zytel FN® formulation have good heat-sealability, formability and oven stability. The dry blend, containing the D12 polyamide, has a lower heat-seal initiation temperature and a higher maximum bond strength than the Zytel FN® formulation. Both retain their film physical properties to a much greater extent than the poly/Nylon/poly coextrusion.

Heat-sealability:

Seal bar width=⅛ inch (0.3175 cm)

Jaw Sealing Pressure=40 psi (276 KPa)

Seal Dwell time=¼ second

Bubble Formability:

Film Preheat time=11 seconds (potentiometer setting=95)

Heat Hold=1.4 seconds. Time between end of preheat and end of heating cycle. (potentiometer setting=60)

Effective vacuum time=0.7 seconds (potentiometer setting=20)

Heat Stability:

Recirculating Hot Air Oven, set at 200 deg C.

Sample films sandwiched between Teflon-coated polyester and placed in oven for one hour.

Film tensile properties measured using ASTM D 882-91.

The above two formulations were made into bubble-pack structures using a commercial process. The bubble pack structures were then placed in a recirculating hot air oven for one hour at 200° C. For both formulations, the bubbles retained their shape after oven heating, i.e. the bubbles did not collapse.

The foregoing is considered to be illustrative only of the principles of the invention. Further, since numerous modifications and changes will occur to those skilled in the art, it is not desired to limit the invention to the exact construction and operation shown and described, and, accordingly, all suitable modifications and equivalents may be resorted to, falling within the scope of the invention.

We claim:

1. An embossed laminate formed from a film made from a multi-phase thermoplastic resin composition, the laminate comprising an embossed layer of the film, heat sealed to an unembossed layer of the same film, the resin composition comprising in combination the following main components:
i) at least one polyamide resin selected from aliphatic and semi-aromatic polyamides that can be either semi-crystalline or amorphous in structure having a number average molecular weight of at least about 5000, having graft sites and forming the continuous phase of the composition, wherein the semi-crystalline polyamides have a melting point greater than 200° C.;
ii) at least one polyamide resin comprising at least one pendant alkyl branch having 1 to 3 carbon atoms within at least two amide linkages along the polymer backbone and at least one sequence of at least seven consecutive carbon atoms, excluding carbon atoms in pendant alkyl branches, if any, within at least two amide linkages along the polymer backbone, the melting point of the polyamide being less than 200° C., having graft sites and also forming the continuous phase of the composition;
iii) at least one ethylene copolymer, E/X/Y, where E is ethylene and is at least 50% by weight of E/X/Y, X is from 1-35% by weight of an acid containing unsaturated mono-carboxylic acid, and Y is 0-49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms, and further wherein from 0-100% by weight of the acid groups in the acid-containing moiety are neutralized with a metal ion;
iv) at least one polymeric grafting agent which contains reactive groups selected from at least one of epoxides, isocyanates, aziridines, silanes, alkyl halides, alpha-halo ketones and aldehydes, or oxazoline, which reacts with the acid-containing moieties in component
iii) and additionally react with the graft sites of components i) and ii), and the weight percent of the monomer(s) containing the reactive groups is 0.5-15 weight percent of the polymeric grafting agent, and the remainder of the polymeric grafting agent contains at least 50% by weight of ethylene and from 0-49% by weight of a moiety derived from at least one alkyl acrylate, alkyl methacrylate, alkyl vinyl ether, carbon monoxide, sulfur dioxide, or mixtures thereof where the alkyl groups contain 1-12 carbon atoms; and
v) at least one C₂-C₂₀ polyolefin selected from polyethylene, polypropylene, ethylene propylene diene terpolymer, copolymers of ethylene with vinyl acetate, carbon monoxide, or ethylenically unsaturated carboxylic acids or esters thereof upon which are grafted from about 0.05 to about 5% by weight of monomers or mixtures of monomers selected from ethylenically unsaturated acidic monomers or their derivatives including acrylic acid, methacrylic acid, maleic acid, fumaric acid, itaconic acid, crotonic acid, 5-norborene-2,3-dicarboxylic acid, maleic anhydride, monomethyl fumarate and monomethyl maleate; and from ethylenically unsaturated monomers containing amino or hydroxy functional groups including vinyl pyridines, vinyl silanes, 4-vinyl pyridine, vinyltriethyloxysilane and allyl alcohol; the components being combined in accordance with one of the following formulation combinations:
A. from about 29 to about 54% by weight of component i), from about 8 to about 70% by weight of component iii), and from about 0.8 to about 45% by weight of component iv);
B. from about 17 to about 54% by weight of component i), from about 1 to about 40% by weight of component ii), from about 5 to about 69% by weight of component iii), and from about 0.5 to about 45% by weight of component iv);
such that the sum of components i) and ii) equals from about 29 to about 72% by weight;
C. from about 55 to about 90% by weight of component i), from about 10 to about 45% by weight of components iii) or v) or mixtures thereof; and
D. from about 15 to about 89% by weight of component i), from about 1 to about 40% by weight of component ii), from about 10 to about 45% by weight of component iii) or v) or mixtures thereof; such that the sum of components i) and ii) equals from about 55 to about 90% by weight;
E. from about 30 to about 91% by weight of component i), from about 1.5 to about 70% by weight of component iii), and from about 0.15 to about 45% by weight of component iv); and
the formulations include antioxidants, heat stabilizers or mixtures thereof.

2. An embossed laminate as claimed in claim 1 wherein the formulation combination is A.

3. An embossed laminate as claimed in claim 1 wherein the formulation combination is B.

4. An embossed laminate as claimed in claim 1 wherein the formulation combination is C.

5. An embossed laminate as claimed in claim 1 wherein the formulation combination is D.

6. An embossed laminate as claimed in claim 1 wherein the formulation combination is E.

7. An embossed laminate as claimed in claim 1 wherein the formulation of combination A comprises:
from 31 to 52% by weight of component (i) which has a number average molecular weight of greater than or equal to 7500,
from 18 to 65% by weight of component (iii), of which the percent of E is greater than or equal to 55% by weight, the percent of X is from 3 to 30% by weight, the percent of Y is from 0 to 35% by weight, all based on the total of component (iii), and from 0 to 80% by weight of the acid groups in X are neutralized by metal ion,
from 3 to 30.5% by weight of component (iv), wherein the percent by weight of monomers containing reactive groups as a percent by weight of the component is from 1 to 10% by weight, the percent by weight of ethylene is greater than or equal to 55, and the alkyl moiety is from 0 to 35 percent by weight.

8. An embossed laminate as claimed in claim 1 wherein the combination of formulation A comprises:
from 32 to 50% by weight of component (i) which has a number average molecular weight of greater than or equal to about 10,000,
from 25.5 to 60% by weight of component (iii), of which the percent of E is greater than or equal to 60% by weight, the percent of X is from 5 to 15% by weight, the percent of Y is from 0 to 25% by weight, all based on the total of component (iii), and from 0 to 75% by weight of the acid groups in X are neutralized by metal ion, and
from 5 to 20.5% by weight of component (iv), wherein the percent by weight of monomers containing reactive groups as a percent by weight of the component is from 1 to 7% by weight, the percent by weight of ethylene is greater than or equal to 60, and the alkyl moiety is from 0 to 35 percent by weight.

9. An embossed laminate as claimed in claim 1 wherein the combination of formulation E comprises:
from 32 to 76% by weight of component (i) which has a number average molecular weight of greater than or equal to about 7500,
from 9 to 65% by weight of component (iii), of which the percent of E is greater than or equal to 55% by weight, the percent of X is from 3 to 30% by weight, the percent of Y is from 0 to 35% by weight, all based on the total of component (iii), and from 0 to 80% by weight of the acid groups in X are neutralized by metal ion, and
from 1.5 to 30.5% by weight of component (iv), wherein the percent by weight of monomers containing reactive groups as a percent by weight of the component is from 1 to 10% by weight, the percent by weight of ethylene is greater than or equal to 55, and the alkyl moiety is from 0 to 35 percent by weight.

10. An embossed laminate as claimed in claim 1 wherein the combination of formulation E comprises:
from 32 to 65% by weight of component (i) which has a number average molecular weight of greater than or equal to about 10,000,
from 18 to 60% by weight of component (iii), of which the percent of E is greater than or equal to 60% by weight, the percent of X is from 5 to 15% by weight, the percent of Y is from 0 to 25% by weight, all based on the total of component (iii), and from 0 to 75% by weight of the acid groups in X are neutralized by metal ion, and
from 3.5 to 20% by weight of component (iv), wherein the percent by weight of monomers containing reactive groups as a percent by weight of the component is from 1 to 7% by weight, the percent by weight of ethylene is greater than or equal to 60, and the alkyl moiety is from 0 to 35 percent by weight.

11. An embossed laminate as claimed in claim 1 wherein the combination of formulation C comprises:
from 60 to 80% by weight of component (i), which has a number average molecular weight of greater than or equal to 7500,
from 20 to 40% by weight of component (iii) or component (v) or mixtures thereof, wherein E is greater than or equal to 55% by weight, X is from 3 to 30% by weight, Y is from 0 to 35% by weight based on the total amount of component (iii), and from 0 to 80% by weight of the acid groups in the acid containing moiety are neutralized.

12. An embossed laminate as claimed in claim 1 wherein the combination of formulation C comprises:
from 60 to 75% by weight of component (i), which has a number average molecular weight of greater than or equal to 10000,
from 25 to 40% by weight of component (iii) or component (v) or mixtures thereof, wherein E is greater than or equal to 60% by weight, X is from 5 to 15% by weight, Y is from 0 to 25% by weight based on the total amount of component (iii) and from 0 to 75% by weight of the acid groups in the acid containing moiety are neutralized.

13. An embossed laminate formed from a film made from a multi-phase thermoplastic resin composition, the laminate comprising an embossed layer of the film, heat sealed to an unembossed layer of the same film, wherein the combination of formulation B comprises:
from 20 to 49% by weight of component (i), which has a number average molecular weight of greater than or equal to 7500,
from 5 to 35% by weight of component (ii), the total of components (i) and (ii) being equal to from about 34 to about 69% by weight,
from 12 to 62% by weight of component (iii), wherein E is greater than or equal to 55% by weight, X is from 3 to 30% by weight, Y is from 0 to 35% by weight based on the total of component (iii), and the percent by weight neutralization by metal ion of acid groups in X is from 0 to 80, and
from 2 to 29% by weight of component (iv), of which from 1 to 10% by weight of monomers containing reactive groups are present therein, the percent by weight of ethylene is greater than or equal to 55 therein, and the alkyl moiety therein is from 0 to 35 percent by weight.

14. An embossed laminate formed from a film made from a multi-phase thermoplastic resin composition, the laminate comprising an embossed layer of the film, heat sealed to an unembossed layer of the same film, wherein the combination of formulation B comprises:
from 22 to 45% by weight of component (i), which has a number average molecular weight of greater than or equal to 10000,
from 10 to 30% by weight of component (ii), to the total of components (i) and (ii) being from 39 to 65% by weight,
from 18 to 54% by weight of component (iii), wherein E is greater than or equal to 60% by weight, X is from 5 to 15% by weight, Y is from 0 to 25% by weight based on the total of component (iii), and the percent by weight neutralization of acid groups by metal ion in X is from 0 to 75, and
from 3.5 to 18% by weight of component (iv), of which from 1 to 7% by weight of monomers containing reactive groups are present therein, the percent by weight of ethylene is greater than or equal to 60 therein, and the percent by weight of alkyl moiety therein is from 0 to 35.

15. An embossed laminate formed from a film made from a multi-phase thermoplastic resin composition, the laminate comprising an embossed layer of the film, heat sealed to an unembossed layer of the same film, wherein the combination of formulation D comprises:
from 25 to 75% by weight of component (i), which has a number average molecular weight of greater than or equal to 7500,
from 5 to 35% by weight of component (ii), the total of components (i) and (ii) being from about 60 to about 80% by weight, and
from 20 to 40% by weight of component (iii) or component (v) or mixtures thereof, wherein E is greater than or equal to 55% by weight, X is from 3 to 30% by weight, Y is from 0 to 35% by weight based on the total amount of component (iii) and from 0 to 80% by weight of the acid groups in the acid containing moiety are neutralized.

16. An embossed laminate formed from a film made from a multi-phase thermoplastic resin composition, the laminate comprising an embossed layer of the film, heat sealed to an unembossed layer of the same film, wherein the combination of formulation D comprises:
from 30 to 65% by weight of component (i), which has a number average molecular weight of greater than or equal to about 10,000,
from 10 to 30% by weight of component (iii), the total of components (i) and (ii) being from 60 to 75% by weight; and
from 25 to 40% by weight of component (iii) or component (v) or mixtures thereof, wherein E is greater than or equal to 60% by weight, X is from 5 to 15% by weight, Y is from 0 to 25% by weight based on the total of amount of component (iii) and from 0 to 75% by weight of the acid groups in the acid containing moiety are neutralized.

17. A high temperature heat shield assembly comprising at least one layer of embossed laminate as claimed in claim 1, and having adhered thereto at least one layer of a reflective material.

18. A high temperature heat shield assembly as claimed in claim 17 wherein the assembly comprises a plurality of embossed laminate layers arranged in suitable sequence to produce a heat shield effect, with at least one reflective layer as an exterior layer and at least one embossed laminated layer as an interior layer.

19. A cushioning or protective assembly which comprises at least one layer of the embossed laminate of claim 1.

20. A method for producing a heat formed, flexible, thermoplastic, embossed laminate, wherein a resin is formed by blending the components of one of the formulations as defined in claim 1 and the resin is extruded, passed through a die and immediately into an embossing and laminating process.

21. A method for producing a heat formed, flexible, thermoplastic, embossed laminate, wherein a resin is formed by blending the components of one of the formulations as defined in claim 1, and the resin is extruded and passed though a die to form a film or sheet or layer which is subsequently subjected to an embossing and laminating process.

22. A method for producing a heat formable laminating film or sheet or layer wherein a resin formulation as claimed in claim 1 is extruded and passed through a die to form a film or sheet or layer.
